(19) United States
(12) Patent Application Publication
(10) Pub. No.: US 2014/0142963 A1
(43) Pub. Date: May 22, 2014

(54) System and Method for Providing Patient Care

(71) Applicant: Spacelabs Healthcare LLC, Snoqualmie, WA (US)

(72) Inventors: Tim Hill, Woodinville, WA (US); Patrick Scott Jensen, Sammamish, WA (US); James M Owen, Redmond, WA (US); Jeffrey Jay Gilham, Sammamish, WA (US); Roy Hays, Seattle, WA (US); James Dundon, Kent, WA (US)

(73) Assignee: Spacelabs Healthcare LLC, Snoqualmie, WA (US)

(21) Appl. No.: 14/044,524

(22) Filed: Oct. 2, 2013

Related U.S. Application Data
(60) Provisional application No. 61/709,883, filed on Oct. 4, 2012.

(51) Int. Cl. G06F 19/00

(52) U.S. Cl. CPC G06F 19/322
USPC 705/2

(57) ABSTRACT

A system for providing patient care includes acquiring, consolidating, distributing, storing and displaying medical data using cell phone platforms and non-proprietary hardware and software modules. The system includes sensing devices, acquisition devices, network appliances, cloud computing and storage, and presentation devices. Sensing devices are connected to acquisition devices via wired or wireless connections. Sensing acquisition devices can be used in a caregiver facility and in an outpatient environment and can connect to the cloud via cell phone (3G/4G) networks. Clinical data is sent in encrypted messages having only the header encoded using a standard scripting language, such as Lua. Presentation devices include computers, tablets, cell phones, and wall-mounted displays and can be located anywhere, enabling greater accessibility of patient data by caregivers.

### CROSS-REFERENCE TO RELATED APPLICATIONS

The present specification claims priority to U.S. Provisional Patent Application No. 61/709,883, entitled “System and Method for Providing Patient Care” and filed on Oct. 4, 2012, which is herein incorporated by reference in its entirety.

### FIELD

The present specification relates to medical systems. More particularly, the present specification relates to a distributed patient monitoring system and method for providing patient care that enables existing cell phone networks, cloud-based services, consumer electronic devices, and connectivity to standard networks to acquire, consolidate, analyze, distribute, store and display medical data.

### BACKGROUND

Standard systems for providing patient care usually employed in hospital environments include modules for acquiring, consolidating, distributing, storing and displaying patient medical data. Such modules comprise various hardware components running a number of software programs, usually connected by an information network. Currently available systems for providing patient care use proprietary hardware, thereby limiting options for expansion and constricting the use of the systems. In most cases the systems allow only specific application software that has been designed as per the system run requirements. In addition, due to periodic upgrades and updates, hospital environments often have multiple versions of both hardware and software operating on their systems. Hence, these systems tend to be like closed boxes that may be customized only to a limited extent. As technology advances, hospitals encounter increasing difficulties integrating new functionality with existing systems. Typically, an on-site information technology (IT) staff is required to perform manual upgrades and troubleshooting.

Current systems for providing patient care include networks utilizing traditional communications protocols which must strictly define the format, schema, and encoding of the messages that comprise the protocol. These definitions form a contract between a transmitter of information and a receiver of information within the system and are typically in the form of either rigorous “bit-level” encodings or higher level encodings, such as Extensible Markup Language (XML). “Bit-level” encoding involves a precise layout of every bit and byte of each message at the binary level and thus rigorously defines the exact format and content of all messages in the protocol. TCP/IP protocol used on the internet is an example of “bit-level” encoding. XML encoding uses a protocol-specific schema to layer the necessary rules on top of a standardized format (XML) to define the layout of messages. Hyper text markup language (HTML) web page standard is an example of XML encoding.

Both types of encoding require that the transmitter and receiver agree upon the same protocol. A receiver expecting XML data would be unable to process binary data from a transmitter and vice versa. Therefore, changes and enhancements to the protocol must be made in lock-step, with the transmitter and receiver being updated simultaneously. Current systems are usually widely deployed, making such simultaneous upgrades impractical and resulting in protocols becoming “locked in” with very little evolution.

Additionally, transmission of information via standard protocol involves several conversion steps. The transmitter must encode data before sending it and the receiver must decode the data to recover it. Continual encoding and decoding of data can be complex and can significantly increase overhead. Making changes to the underlying protocol typically requires reworking of both the encoding and decoding stages, also leading to increased costs.

Communications protocols in typical networks come in two basic types: connection-oriented and connectionless. Connection-oriented protocols require a handshake procedure between the two communicating parties before data exchange can take place, while connectionless protocols allow data exchange without a preceding setup or handshake.

Securing communications is typically performed using encryption, and all extant forms of encryption require the communicating parties to have shared secrets, typically in the form of keys, that allow them to encrypt and decrypt messages. While there are many techniques for sharing keys, all involve the use of a connection-oriented protocol so that keys can be exchanged during the setup of the connection. Furthermore, each individual connection must specify a unique set of secrets. Thus, if a first agent is communicating with 100 other agents, each individual conversation involves an individual encrypted connection, requiring the first agent to manage 100 simultaneous connections and associated keys. As such, in systems where many agents talk to many others, the total number of connections increases exponentially. This will increase costs and slow the system.

To overcome this, many systems use a single central “exchange” that routes communications between agents. The total number of connections is then equal to the number of agents since each agent has only to connect to the shared central exchange. However, unless the exchange is trusted, the agents must still maintain individual encryption key pairs for each pair of communicating agents. Thus, the agents must still “connect” to exchange keys.

The messages sent between the transmitters and receivers will vary in importance and priority from the trivial to the critical. Since it is generally extremely difficult or impossible to guarantee the delivery of a given message, it is often useful for the receiver of a message to acknowledge receipt to the sender of the data. As this receipt generation consumes network bandwidth (at least one new message is generated by the receiver for every message received), it is often reserved for messages of the highest importance.

As with message encoding, traditional communications protocols form a contract between transmitters and receivers and must rely upon strictly defined rules for the specification that the receivers generate and send a delivery receipt. Typically, the protocol will specify a field or sequence of fields that must be decoded to determine if a receipt message is to be generated. Additional fields define the format of the receipt message and the network address of the sender. In order for a traditional network system to guarantee receipt generation effectively, all the agents on the network must be running compatible versions of the protocol such that messages receipt requests, format descriptors and address designations are all in compatible formats.

In addition, traditional message receipt generation is quite restrictive in that the format of the return receipt is determined by the functionality encoded in the receivers software stack. If a complex sequence of actions is desired upon receipt of a particular class of messages, it must be encoded in the software stack of every network agent.

For example, a class of critical messages requires that not only a standard receipt be generated (a message returned to sender), but also that a secondary message receipt notification be sent to a data logging server (which tracks all high priority message receipts). In a traditional system, this behavior would have to be built into the message protocol such that additional optional data fields (secondary receipt notification enable, address of secondary notification server, specified behavior if a secondary server is not available, etc.) would be used for implementation. This is a complex response upon message receipt that is difficult to encode in a traditional protocol. The effect is to grow the size of all messages and to make the protocol progressively more complex, slower, and difficult to use and to maintain.

With every new behavior that is encoded in the protocol in this manner, the network software stacks on all the network agents grow in complexity and memory consumption and become less efficient. In addition, such a feature cannot be used until all the network agents are running a compatible version of the protocol that supports the feature.

When sending messages, typical networks also rely on a variety of protocols to determine the optimal route for data packets. These protocols determine the optimal path between endpoints using static cost metrics. Most are based on Dijkstra's algorithm, a graph search algorithm that solves the single-source shortest path problem for a graph with nonnegative edge path costs, for determining the shortest path between two vertices. Each link is assigned a cost based on a specific attribute, which is usually the bandwidth available.

The routing protocol Open Shortest Path First (OSPF) is a common example of a route determining protocol. While other attributes are available, OSPF is commonly configured to assign each available network link a cost of 10̂8/bandwidth. A link of 100 Mbit/s of bandwidth would have a cost of 1 and a link of 10 Mbit/s would have a cost of 10. In selecting a path between two networks, OSPF will choose the path with the lowest cost.

Spanning Tree Protocol (STP), a link layer protocol, also selects optimal paths for a network based on available interface bandwidth using a default cost table. For STP, 10 Mbit/s is given a cost of 100, while 100 Mbit/s is given a cost of 19. The sum of all links on each path is used to determine the path cost, with the lowest cost path chosen for communications on that network.

In these protocols, the path cost is determined according to the negotiated link speed for each interface. However, actual transmission speed can be impacted in real time by network congestion, packet loss, and queuing delay. These properties change dynamically and are not considered when the optimal path is computed using static cost metrics.

Typical networks use various protocols to transfer data from one or many transmitters to many other receivers. The transfer of data from one or many senders simultaneously to multiple recipients is termed multicasting. Protocol-independent multicast (PIM) is a group of protocols that do not include their own topology discovery mechanism but use routing information provided by other protocols. Internet group management protocol (IGMP) is used by hosts and routers on networks to establish multicast group memberships. When operating on a typical network using IGMP, a device must re-sync state, or re-establish connection, with a host or router whenever the device is roaming. Maintaining state across routers during roaming requires that the system retain session information or status of devices during multiple requests. This slows down the system and increases the need for additional memory storage.

Many of the transmitters and receivers transferring messages in typical networks are mobile devices. These devices often have a limited power budget for the transmission of data. They are generally powered by batteries and it is not uncommon for radio transmission (blue-tooth, 802-11 wireless, 3G, 4G, LTE etc.) to use a large percentage of the available power and total energy in the battery. This problem is particularly acute if the device is sending data continuously as might be seen in mobile devices used as part of a medical monitoring system.

Another problem encountered when multicasting over mobile networks occurs when duplicate messages are sent by a transmitter. When sending messages using radio frequency (RF) transmission as described above, systems are limited in the amount of data they can transfer by the amount of bandwidth available and the battery power of the mobile devices. Requiring more bandwidth for RF interconnections is associated with an increase in overall cost of the system. Duplicate message sending not only consumes more bandwidth but also results in unnecessary battery drain on mobile devices.

When alarming, traditional systems for providing patient care are typically configured to annunciate alarms first and foremost at the device connected to the patient. Alarms that are generated by the device connected to the patient are often replicated and displayed at remote physical devices such as at a central workstation. A central workstation is a large display typically used by a single caregiver to watch the status of multiple patients. In addition, mobile alarming devices may be worn by caregivers as they move about the care unit. These devices are capable of notifying the caregiver if one of their patients has an alarm event.

These alarm approaches all provide a programmed response to an alarm condition that typically follows the path of: 1) alarming at the device connected to the patient; 2) alarming at the central or remote display; 3) notifying the caregiver of the alarm; and, 4) if the caregiver does not respond, then notifying another caregiver based on a pre-defined escalation until a caregiver responds. While effective, traditional alarming schemes do not take into account the physical location of the patient or nearest caregiver which can lead to delays in alarm response.

Alarm fatigue is another problem encountered by caregivers using traditional patient care systems. When a patient monitor detects a condition for which it should create an alarm, it will create notifications for the caregiver, such as, a loud audible repeating tone, a flashing indicator on the device or display, a text message describing the alarm, etc. After a caregiver responds to numerous alarms for many different patients during a shift, the caregiver might become desensitized to the alarm tones. This can lead to patient harm if important alarms are either ignored or inappropriately disabled by the caregiver. Existing patient monitoring systems attempt to minimize alarm fatigue by enabling caregivers to “silence” alarms during certain situations. Silencing an alarm does not turn the alarm off but instead will typically turn off the audio alarm tones for a period of time so the caregiver is not distracted while attending to the patient.

“Alarm silence” is a form of silencing that turns off the audio alarms for a selectable period of time. “Alarm acknowledge” (ongoing alarm) reduces the intensity of the alarm notification during the duration of the alarm situation. If at any time the alarm condition goes away, the “alarm acknowledge” state clears and a new alarm of the same type would cause the full alarm behavior to occur again. For example, for an alarm condition such as atrial fibrillation (which is not typically life threatening and may go on for extended periods of time), the alarm acknowledge behavior can be to stop flashing and stop audible alarms but still indicate the alarm is occurring in the parameter zone along with an icon indicating that the caregiver has acknowledged the alarm condition. This state would persist until the alarm was either reset or until the condition resolved. If the patient came out of atrial fibrillation for at least a minimum specified period of time and then re-entered, the full alarm appropriate for atrial fibrillation would start again.

“Alarm acknowledge” (latched alarm) is for alarm situations sufficiently important that if they occur then a caregiver must be informed. If a latched alarm occurs, then the patient monitor will continue to alarm even after the alarm condition is no longer present until a caregiver “acknowledges” that the alarm has been observed. Once acknowledged, the alarm will turn off if the condition is no longer present. While these alarm silencing schemes are effective, they can be improved to be better distributed and oriented toward a caregiver team approach.

Further, current systems are usually fixed and cannot be used to provide patient care once a patient has been moved out of a hospital environment. Such systems do not provide a method for patients and their caregivers to connect to physicians and healthcare professionals once a patient has been discharged but still requires medical attention.

Hence, what is required is a flexible and robust system for providing patient care that is not limited to the use of proprietary technology. The new system should be flexible enough to provide support for several years without the need to replace base modules. The system should also require little onsite technical expertise. Such a system would operate using software-as-a-service (SaaS) principle, wherein caregivers, patients, and families access programs and data stored on a cloud. The cloud provides the computing and storage requirements of the system, shifting use away from thick clients where programs and data are stored locally. Cloud computing will decrease costs and increase flexibility of the system.

Also needed is a system wherein message encoding is handled in a more efficient and cost effective manner. Specifically, what is needed is a flexible encoding protocol that simplifies that encoding and decoding steps and allows enhancements to the system without requiring simultaneous upgrades of system components. Such an encoding protocol would also simplify the inclusion of executable programs in the message transmission, such as, delivery receipt programs.

Additionally, there is a need for a connectionless exchange for sending encrypted messages between two parties without requiring those parties to negotiate keys or other secrets prior to the exchange of the message. What is needed is a central, trusted exchange for the connectionless transmission of messages across the network.

What is also needed is a message routing protocol that will consider real time network usage, such as congestion, packet loss, and queuing delay, when determining the fastest route.

Also needed is a system capable of efficient multicasting wherein devices can enter roaming without the need for re-syncing with routers, keeping router operation stateless. Such a system would reduce battery consumption on the devices and lessen demands on the network. In addition, a system is needed that will minimize bandwidth and mobile device battery consumption by reducing the incidence of duplicate message sending.

What is also needed is a method of controlling the flow of messages over a network to minimize power consumption in the transmitter. Wireless devices are generally more efficient when they transmit a single block of data of a certain number of bytes than if the same bytes are transmitted as multiple smaller blocks of data. Therefore, what is needed is a method of sending multiple messages together in a single block rather than as multiple smaller messages.

There is a need for alarm priority routing based on location and presence information of both the patient and caregivers. Also needed is a method for alarm silencing that considers a distributed team of caregivers.

There is also a need for a system wherein individual hardware modules are sufficiently small and mobile to allow for transfer across hospital departments and to be sent home with patients for a limited time after discharge.

There is a need for a system wherein individual hardware modules are configurable to interface with different type of patient sensors to provide appropriate care for the patient from the hospital environment to the outpatient setting.

What is also needed is a system that provides ubiquitous patient vigilance by allowing patients, their families, and caregivers to connect in a safe and reliable way. There is also a need for a system for providing patient care that supports the use of third party solutions, by adapting the system to receive patient physiological data from third party devices and other information generated from analysis of data, thereby encouraging innovation.

### SUMMARY

The present specification is directed toward a system for providing patient care comprising: a first computing device having a first volatile or non-volatile computer readable medium, not including transmission media for transmitting waves, wherein said first medium comprises: a first plurality of programmatic instructions, wherein, when executed by said first computing device, said first plurality of programmatic instructions: encrypt, using a standard scripting language, an executable program and attach said encrypted program to the header of a message; and, transmit said message from the first computing device to a second computing device via a wireless connection; a second computing device having a second volatile or non-volatile computer readable medium, not including transmission media for transmitting waves, wherein said second medium comprises: a second plurality of programmatic instructions, wherein, when executed by the second computing device, said second plurality of programmatic instructions: receive said message from said first computing device; determine, from said message, at least one target computing device intended to receive said message; and, transmit said message from said second computing device to said at least one target computing device via a wireless connection; and, at least one target computing device having a third volatile or non-volatile computer readable medium, not including transmission media for transmitting waves, wherein said third medium comprises: a third plurality of programmatic instructions, wherein, when executed by the third computing device, said third plurality of programmatic instructions: receive said message from said second computing device; decrypt said executable program; and, execute said executable program and thereby receive said message; wherein said second computing device is a cloud based computing device.

The present specification is also directed toward a system for providing patient care comprising: at least one sensing device configured to detect and report at least one physiological parameter of a patient; at least one acquisition device coupled to said at least one sensing device wherein said acquisition device receives electronic patient data from said at least one sensing device and includes memory capable of storing said patient data; at least one network appliance coupled to said at least one acquisition device wherein said network appliance is configured to receive said patient data from said acquisition device; a network for providing cloud computing wherein said at least one network appliance is coupled to said network and wherein said network includes a database for storing said patient data such that said patient data is accessible across all network devices; and, at least one presentation device coupled to said network wherein said presentation device is configured to access said patient data and display said patient data on a graphical user interface, wherein transmission of said electronic patient data across said network includes encrypting said patient data by encoding an executable program using a standard scripting language and attaching said program to a message that includes said patient data.

In one embodiment, the network appliance is located in proximity to the patient. In another embodiment, the network appliance is located remotely from the patient.

In one embodiment, the sensing device is coupled to said at least one acquisition device via a wired connection. In another embodiment, the sensing device is coupled to said at least one acquisition device via a wireless connection.

In one embodiment, both said at least one sensing device and said at least one acquisition device can connect to the network via a 3G/4G connection.

In one embodiment, the standard scripting language is Lua.

In one embodiment, the presentation device comprises any one of a traditional PC, tablet, smartphone, or wall-mounted display.

In one embodiment, the acquisition device also functions as a presentation device.

In one embodiment, the acquisition device duplicates and stores all clinical data for said patient on said memory and functions as a standalone monitor in the event of system failure.

In one embodiment, the acquisition device is a fixed device at a caregiver facility. In another embodiment, the acquisition device is a mobile device that remains with said patient upon discharge and for outpatient care.

In one embodiment, the system for providing patient care further includes a cost-based routing algorithm that calculates the most efficient message route by directly measuring current network performance during actual usage.

In one embodiment, the system for providing patient care further includes an alarm routing protocol that routes alarm priority based on the location and presence information of both said patient and a caregiver. In one embodiment, a caregiver can silence or reduce in volume an audible alarm for all devices assigned to said patient.

In one embodiment, the system for providing patient care further includes a central trusted message exchange that establishes a once-per-device encrypted link between the exchange and each message transmitter and receiver. In one embodiment, the central message exchange clusters non-urgent messages to be sent periodically. In one embodiment, the message transmitter is configured to send each message only once and said central message exchange is configured to duplicate and send each message to multiple recipients based on a subscription list included in a header of said message.

The present specification is also directed toward a method for providing patient care comprising the following steps: providing a patient care system that comprises: at least one sensing device configured to detect and report at least one physiological parameter of a patient; at least one acquisition device coupled to said at least one sensing device wherein said acquisition device receives electronic patient data from said at least one sensing device and includes memory capable of storing said patient data; at least one network appliance coupled to said at least one acquisition device wherein said network appliance is configured to receive said patient data from said acquisition device; a network for providing cloud computing wherein said at least one network appliance is coupled to said network and wherein said network includes a database for storing said patient data such that said patient data is accessible across all network devices; and, at least one presentation device coupled to said network wherein said presentation device is configured to access said patient data and display said patient data on a graphical user interface, detecting and reporting said at least one patient physiological parameter using said at least one sensing device; transmitting electronic data representative of said at least one physiological parameter to said acquisition device; encrypting said patient data by encoding an executable program using a standard scripting language and attaching said program to a message that includes said patient data; transmitting said encrypted data to said network appliance; storing said data on said network using cloud computing; accessing, decrypting, and displaying said data using said presentation device.

The aforementioned and other embodiments of the present shall be described in greater depth in the drawing and detailed description provided below.

### BRIEF DESCRIPTION OF THE DRAWINGS

These and other features and advantages of the present invention will be further appreciated, as they become better understood by reference to the detailed description when considered in connection with the accompanying drawing, wherein:

FIG. 1A is a diagram illustrating one embodiment of the workflow of the medical data information system of the present specification;

FIG. 1B illustrates an exemplary usage scenario of the present invention in an intensive care unit (ICU) of a hospital;

FIG. 1C illustrates an exemplary usage scenario of system of the present specification in a general ward of a hospital;

FIG. 1D illustrates an exemplary usage scenario of the system of the present specification in a ‘home’ scenario;

FIG. 2 is a block diagram illustrating an exemplary physical topography of one embodiment of the medical data information system of the present specification;

FIG. 3 is a block diagram illustrating the software architecture of one embodiment of the system portal application;

FIG. 4 is a flow chart illustrating the steps involved in initializing an acquisition device in the medical data information system of the present specification;

FIG. 5 is a flow diagram illustrating one embodiment of the steps involved in an exemplary message exchange between two applications; and,

FIG. 6 is a flow diagram illustrating one embodiment of the flow of messages from a pair of applications in the medical data information system of the present specification.

### DETAILED DESCRIPTION

The present specification is directed toward a system for providing patient care by acquiring, consolidating, distributing, storing and displaying medical data using cell phone platforms and non-proprietary hardware and software modules. In one embodiment, the systems of the present specification are implemented using the following: two or more computers or computing devices, wherein the computers or computing devices execute at least one plurality of programmatic instructions; a means of transferring data between said computing devices; and, at least one protocol designed to facilitate the transfer of data between said computing devices.

In addition, one of ordinary skill in the art would appreciate that the features described in the present application can operate on any computing platform including, but not limited to: a laptop or tablet computer; personal computer; personal data assistant; cell phone; server; embedded processor; digital signal processor (DSP) chip or specialized imaging device capable of executing programmatic instructions or code.

It should further be appreciated that the platform provides the functions described in the present application by executing a plurality of programmatic instructions, which are stored in one or more non-volatile memories, using one or more processors and presents and/or receives data through transceivers in data communication with one or more wired or wireless networks.

It should further be appreciated that each device has wireless and/or wired receivers and transmitters capable of sending and transmitting data, at least one processor capable of processing programmatic instructions, memory capable of storing programmatic instructions, and software comprised of a plurality of programmatic instructions for performing the processes described herein. Additionally, the programmatic code can be compiled (either pre-compiled or compiled “just-in-time”) into a single application executing on a single computer, or distributed among several different computers operating locally or remotely to each other.

The system of the present specification provides one or more sensing devices that collect physiological data from the patient and transmit the sensed data to an acquisition device that then sends the data to the cloud, interconnecting the components of the system. The cloud consolidates the data and then distributes the data to one or more display or presentation devices.

The system enables third parties to innovate and develop applications, thereby leveraging new technologies rapidly. Further, the present system is easy to install, troubleshoot, and service and requires no special hardware, networking, or IT staff. Also, the system is capable of working on a non-robust network infrastructure and has the capability to operate in a fall-back ‘safe’ mode. Yet further, the system for providing patient care comprises a patient monitoring module that may be attached to a patient and may be carried with the patient upon discharge from a hospital and for outpatient care.

In one embodiment, the system uses a communications protocol wherein when sending a message, a transmitter includes a small computer program written in an industry standard scripting language. When a receiver receives the message, it executes the program, yielding the message data in usable form. This eliminates the need of rigorously encoding the message itself and provides greatly enhanced flexibility in message encoding. In one embodiment, the scripting language is Lua. In one embodiment, a transmitter is further capable of creating its own return receipt by inserting executable delivery receipt code in the included program. The receiver will execute the code and send the delivery receipt upon receipt of the original message.

In one embodiment, the system includes a message exchange that uses a cost-based routing algorithm that calculates the most efficient message route using multiple factors including by directly measuring current network performance during actual usage.

In one embodiment, the system provides for the connectionless exchange of encrypted messages by eliminating the need for transmitters and receivers to negotiate keys or other secrets prior to message transfer. This is accomplished by providing a central trusted message exchange that establishes a once-per-device encrypted link between the exchange and each transmitter and receiver.

In one embodiment, the system provides a mechanism for clustering non-urgent messages to be sent periodically rather than continuously, thereby conserving mobile device battery power and bandwidth usage. In addition, the system dictates that messages intended for multiple recipients be sent only once by a transmitter. Each message includes within its header a complete subscription list with all recipients. The system router then duplicates the message and sends it to each recipient. This also helps to reduce battery consumption and overall bandwidth usage.

In one embodiment, the system routes alarm priority based on the location and presence information of both the patient and caregiver. Alarms are sounded both at the location of the responsible caregiver and at the location of at least one caregiver nearest the patient, or a caregiver designated to provide the best care based on the specific type of alarm.

In one embodiment, the system allows caregivers to ‘quench’ an alarm which results in audible alarms being silenced or reduced in volume for all devices assigned to a particular patient.

The present invention is directed toward multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

### System Overview

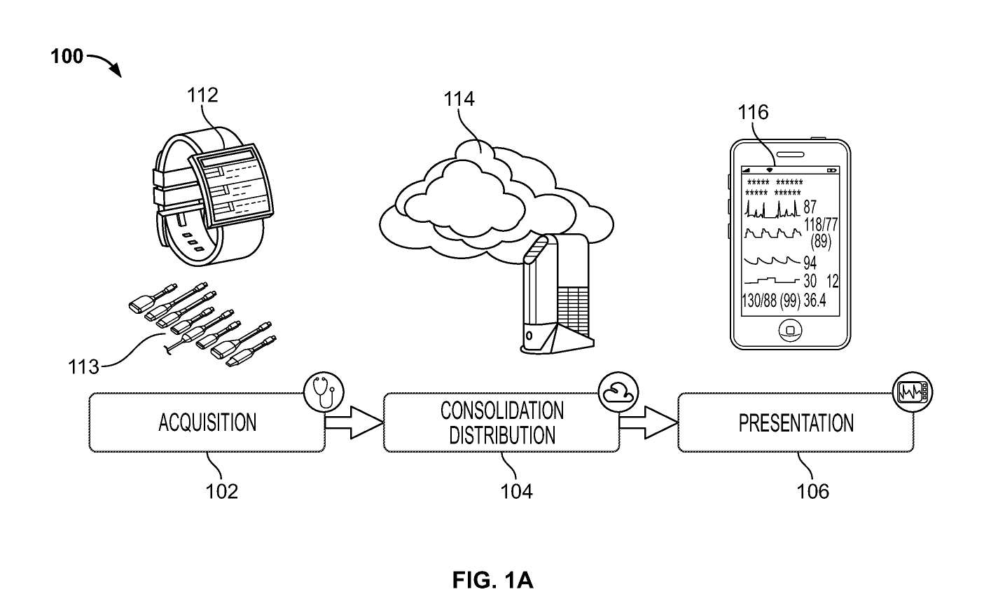

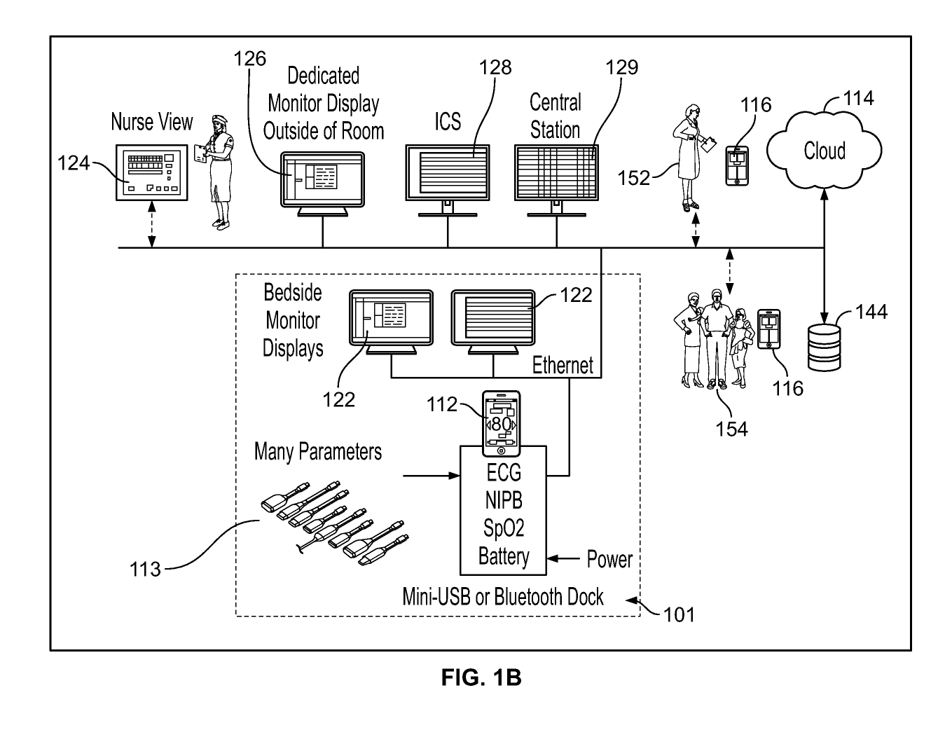

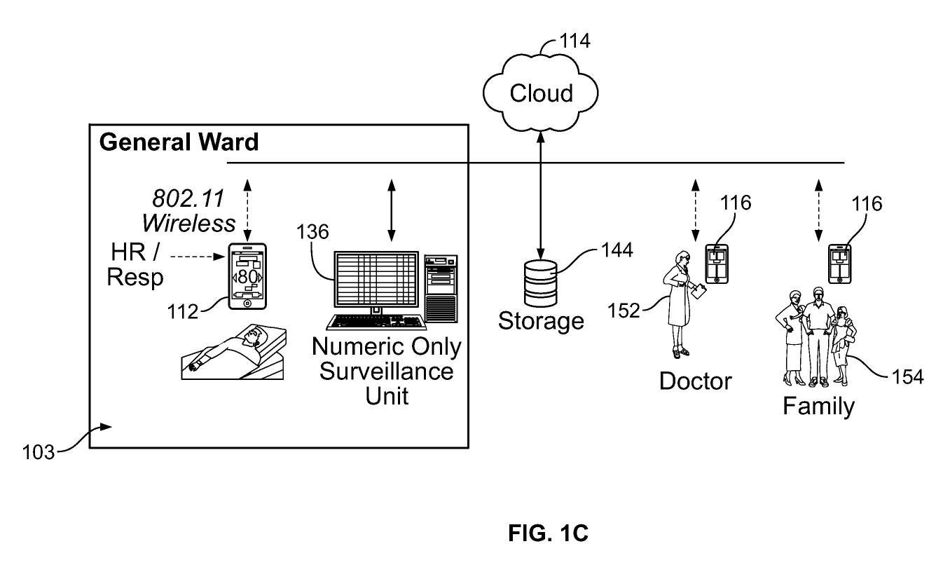

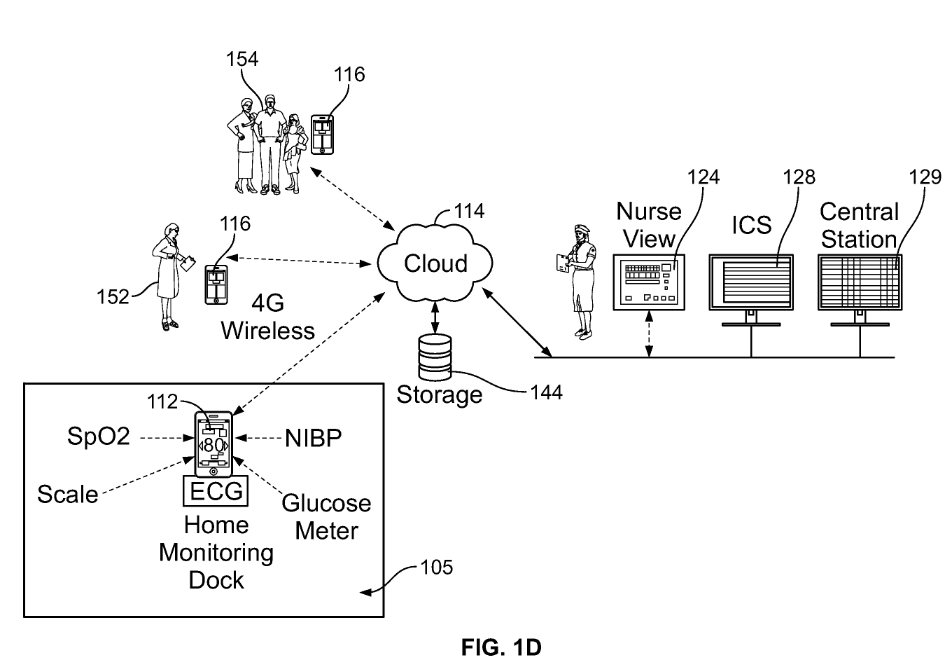

FIG. 1A is a diagram illustrating one embodiment of the workflow 100 of the medical data information system of the present specification. Step 102 represents the acquisition of medical data via sensing devices 113 which, in various embodiments, include commercial, off-the-shelf (COTS) sensors, legacy devices (for input only), and third party devices. In various embodiments, the system comprises a plurality of plug and play applications made available by one or more application providers. The system includes at least one sensing device 113, at least one acquisition device 112, network appliance GHC/cloud 114, and presentation/display devices 116. In one embodiment, the at least one sensing device 113 can be connected to the at least one acquisition device 112 via wired or wireless connections. Sensing devices 113 can be used with an acquisition device 112 in an outpatient environment and, in one embodiment, can connect to the cloud via cell phone (3G/4G) networks. In one embodiment, acquisition device 112 provides a medical information platform comprising an ecosystem, application programming interfaces (APIs), templates, etc. for enabling development of any application, device or service in the healthcare domain. In one embodiment, the acquisition device 112 supports both open source and proprietary products. Since the acquisition devices 112 are provided with built in compliance with the United States' Health Insurance Portability and Accountability Act (HIPAA), platform independence with respect to healthcare related applications is provided. In one embodiment, a plurality of APIs is provided to enable synching of a medical device as well as development of medical software with the acquisition device 112. In various embodiments, the acquisition device 112 receives data from a plurality of third party physiological parameter input sources and medical devices such as ventilators, IV pumps, patient parameter sensing devices, etc. The acquisition device connects to a network appliance GHC that connects to the cloud 114. In one embodiment, the acquisition device 112 is also capable of operating as a presentation device. Hence, the acquisition device 112 enables the system to function as a patient monitoring system and at the same time leverage a plurality of third party applications.

In one embodiment, the acquisition device is capable of providing a second communication technology (i.e., cell phone technology such as 3G/4G) that provides alarm messaging to caregivers. In another embodiment, the acquisition device has a visual indicator (such as a light indicator) or audio indicator that provides critical alarm information only, such as patient id number or bed number and alarm type (heart rate, respiration etc.).

Acquired data is consolidated and distributed at step 104 by the cloud 114. In one embodiment, the cloud is virtual and includes all domains. In other embodiments, the cloud is co-located and includes one or more domains. The cloud 114 provides the processing power for algorithms running on the acquisition devices 112, thereby acting as a local hub. The use of an existing cell-phone based platform enables leveraging consumer technology thereby reducing manufacturing/development cost of a separate parameter consolidation platform. In various embodiments, the cloud 114 enables mobile devices to be connected to patients and operate as patient monitors within a hospital environment. In one embodiment, the cloud 114 also enables mobile devices to be used by nurses and physicians to monitor and care for patients in non-hospital environments. In another embodiment, the cloud 114 enables mobile devices to connect home patients to caregivers via a plurality of medical applications and devices, specifically sensing devices. In yet another embodiment, the cloud 114 enables mobile devices to connect loved ones in retirement homes to caregivers.

In various embodiments, the cloud 114 enables the system to operate efficiently even when underlying networks are not functioning properly. Further, the cloud 114 may operate on any existing network infrastructure and does not require any specific or proprietary hardware/software to be installed for operation. The system is designed to operate in a safe mode wherein at least one patient monitoring device is operational in case of network failure. In the safe mode of operation at least the alarms that are local to a patient would operate even if central monitoring is not available. In the event the connection to the GHC or the network is not operational, the acquisition device and, optionally, the GHC, are capable of analyzing and storing patient physiological data and providing alarm messaging at the patient location. The device stores the data and, when network operation is restored, the data is transmitted to the GHC cloud. The stored information can be the continuous patient physiological signals or the message packets generated for alarming and other information. The acquisition device can also be adapted to receive and present full patient physiological data.

In various embodiments, the cloud 114 comprises data obtained from one or more hospitals or medical centers stored remotely from each of the hospitals or medical centers. Storing patient data in the cloud 114 eliminates the processing delays associated with a regular database management system installed in an organization. Hence, the cloud 114 enables third party consultants as well as remotely placed caregivers to analyze the data stored therein. The cloud also enables third party applications to analyze the data stored in the cloud 114, allowing for processing of physiological and other patient data form multiple sources. In addition, the cloud 114 enables remote triaging of patients. This feature may find immense use in the military conflict arenas and disaster areas, as well as in emerging and developing markets.

After distribution, data is presented at step 106 on display devices 116 including, in various embodiments, traditional PCs, tablets, smartphones, and wall mounted displays. In various embodiments, medical data can be displayed on any display device available in the system 100 infrastructure. The system does not limit the data display to proprietary display devices. The system also allows for simultaneous presentation of patient data to multiple display devices located in a plurality of locations.

In one embodiment, the system of the present specification provides a plurality of cloud based services such as: Patient Resolver, Device Resolver, Policy Engine, Orchestration, and Management. For example, a patient resolver or device resolver service determines a caregiver and/or a medical professional that is at a location nearest to a patient in need of medical attention. In various embodiments, the patient resolver service comprises features such as ‘patient catalogue’, ‘patient ID map’, ‘PHI management’, and ‘session map’. The device resolver service comprises features such as ‘device management’ and ‘session catalogue’. The policy engine service comprises features such as ‘distribution’, ‘security policy’, ‘access control’ and ‘alarm escalate’. The orchestration service comprises features such as ‘workflows’ and ‘dataflows’. The management service comprises features such as ‘domain management’, ‘configuration’, ‘upgrade management’. A central dashboard enables a healthcare provider organization to configure the patient resolver, device resolver, and policy engine based on specific policies of the organization across all facilities of the organization. The central dashboard ensures all devices are compliant to the policies and establishes a uniform standard of care for patients. The cloud based services provide intelligent mapping of patient alarm information to appropriate caregiver based on location, proximity, availability, and skill set.

In one embodiment, the system of the present specification provides a plurality of web applications such as: health system seven (HL7) gateway (bidirectional), patient and family applications, caregiver applications, archiving and printing applications, and administration and dashboard applications.

At step 102, the acquisition devices 112 are actively acquiring clinical data from the patient. In addition, the acquisition devices 112 function as a fallback for both alarms and data display in the event of a failure of the system at large. The inclusion of the acquisition devices 112 as built-in back up helps to lower system costs and minimize system complexity. The functions of the cloud 114 at step 104 include, but are not limited to, device and service discovery, data distribution and storage, security and policy control, patient care report generation, and system metrics and workflows. The cloud system enables licensing of devices, applications, and features from the cloud (marketplace) and then subsequent metering and logging of the use of devices and applications as they are used. Examples include the number and types of parameters attached to specific patients and for what periods of time, the number of devices active on the network, and the number of times a particular feature is used. Knowledge of the actual use of devices, applications, and features enables new and unique billing models. Examples may include pay-per-use for a specific analysis, scalable billing based on the number of patients monitored by the system, scalable billing based on the acuity level of the patient (i.e. number of parameters being monitored). Traditional patient monitoring systems are sold as capital equipment items. The capability of the cloud system moves traditional capital equipment purchases to a services model. The display devices 116 included in step 106 provide for the display of clinical data, alarm expression, and overall patient supervision. In addition, in one embodiment, each display device 116 includes a graphical user interface (GUI) to allow caregivers to perform clerical duties.

In one embodiment, the acquisition devices 112 are located both at the caregiver facility and at the patient's home and are extensible to accommodate independent hardware vendor (IHV) devices and foreign system imports. In one embodiment, the network appliance GHC is located at the caregiver facility and is extensible to accommodate independent software vendor (ISV) applications and foreign system interfaces. In one embodiment, the display devices 116 can be located anywhere and are extensible to accommodate ISV applications.

FIG. 1B illustrates an exemplary usage scenario of the present invention in an intensive care unit (ICU) 101 of a hospital. An acquisition device 112 capable of detecting a plurality of parameters via sensing devices 113 is used to measure and collect patient data. Bedside monitor displays 122 are coupled with the acquisition device 112 via an Ethernet connection to display a patient's vital statistics. The acquisition device 112 is also coupled with a plurality of patient monitors, such as a nurse's monitor 124, a dedicated monitor display outside the patient's room 126, an incident command system (ICS) monitor 128 and a central station monitor 129. The acquisition device 112 and the plurality of displays are coupled with the cloud 114 provided by the present specification. The cloud 114 is in turn coupled with a data storage platform 144 for storing patient related data. The cloud 114 enables caregivers 152 to access a patient's records via a mobile display device 116 and also enables the patient's family 154 to monitor the patient's status via a mobile display device 116 at a location away from a hospital environment. The cloud 114 also enables combinatorial analysis from multiple physiological parameters collected over time. This includes sensor devices developed as part of the system and third party sensor devices.

FIG. 1C illustrates an exemplary usage scenario of system of the present specification in a general ward 103 of a hospital. An acquisition device 112 is used as a parameter consolidation platform receiving a patient's medical data such as heart rate (HR), respiration rate, etc. In the pictured embodiment, the acquisition device 112 also acts as the patient's bedside monitor. The acquisition device 112 is coupled wirelessly with the cloud 114 provided by the system of the present specification. The cloud 114 is in turn coupled with a data storage platform 144 for storing patient related data. In addition, the cloud 114 is coupled with a surveillance unit 136 for displaying the vital statistics of all the patients admitted in the general ward. The cloud 114 enables caregivers 152 to access a patient's records via a mobile display device 116 and also enables the patient's family 154 to monitor the patient's status via a mobile display device 116 at a location away from a hospital environment. The cloud system provides the capability for the family to access patient care information and review patient care history, work flow, confirm and receive updates on discharge instruction, and billing review, thus potentially reducing patient care errors.

FIG. 1D illustrates an exemplary usage scenario of the system of the present specification in a ‘home’ 105 scenario. A mobile acquisition device 112, such as a cell phone or other, separate device, is installed at a patient's home for use as a parameter consolidation platform receiving a patient's medical data such as heart rate (HR), respiration rate, glucose level, etc. The acquisition device 112 also acts as the patient's home monitoring dock. The acquisition device 112 is coupled with the cloud 114 provided by the system of the present specification. The cloud 114 is in turn coupled with a data storage platform 144 for storing patient related data. The cloud 114 is also coupled with a plurality of monitors, such as a nurse's monitor 124, an ICS monitor 128, and a central station monitor 129 for displaying the vital statistics of the patient on a real time basis. The cloud 114 enables caregivers 152 to access the patient's records and monitor the patient's health via a mobile display device 116 and also enables the patient's family 154 to monitor the patient's status via a mobile display device 116 at a location away from a hospital environment.

### System Topography

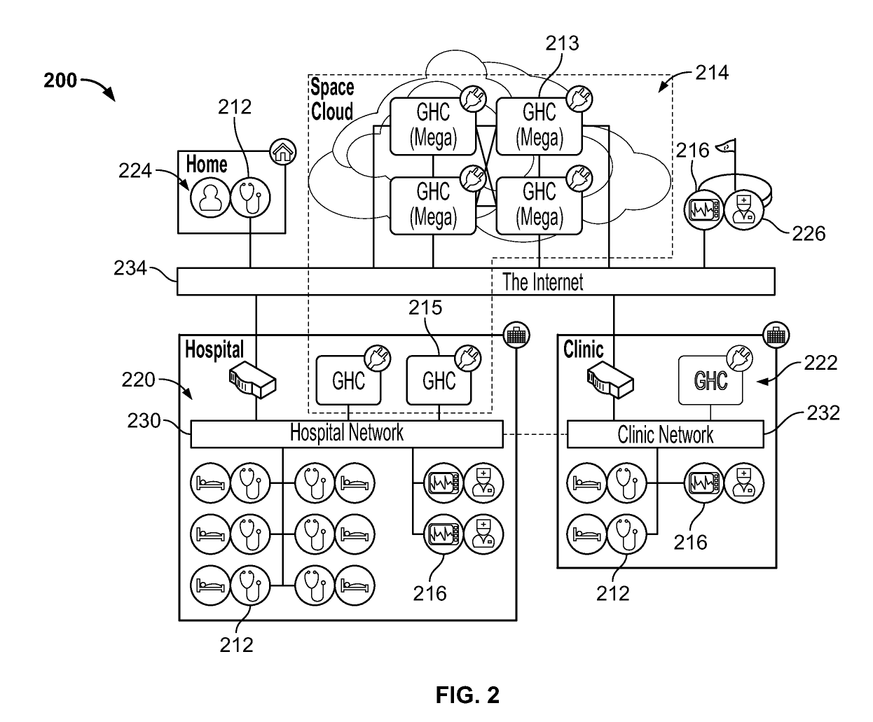

FIG. 2 is a block diagram illustrating an exemplary physical topography of one embodiment of the medical data information system 200 of the present specification. In one embodiment, the system 200 includes sensing/acquisition devices 212 (corresponding to sensing device 112 and/or acquisition device 113 of FIG. 1A) for the acquisition of patient data and display devices 216 (corresponding to the display device 116 of FIG. 1A) for the presentation of patient data. In another embodiment, the system 200 includes devices capable of both acquiring data and presenting data. A traditional patient monitor can function as both an acquisition device and a presentation device. The system 200 also includes a cloud 214 comprising a plurality of global health connectors (GHC) 213, 215 that are responsible for the consolidation and distribution of patient data. A GHC is a network hardware appliance with integrated software that attaches to the network. In one embodiment, the system 200 includes both GHCs 215 that are co-located with the caregiver facility, for example, a hospital 220, and GHCs 213 that are located within the cloud 214. The GHCs 213, 215 act to connect the acquisition devices 212 and display devices 216 of the system 200. In one embodiment, the acquisition devices 212 and display devices 216 are connected via a new media or message exchange switch fabric. The cloud 214 connects all GHCs 213, 215 as peers in a redundant routable backbone and binds all sensing devices 212 and display devices 216 to establish global patient vigilance. In other words, all patient data is gathered and distributed by the cloud such that, at all times and given the proper access, any display device can present data for any patient across the system.

As seen in FIG. 2, sensing devices 212 can be located at a hospital 220, clinic 222, and at the patient's home 224. Display devices can be located at a hospital 220, clinic 222, and with caregivers 226. Sensing devices 212 and display devices 216 in hospitals 220 and clinics 222 are connected via hospital networks 230 and clinic networks 232 respectively, and all devices are interconnected through the cloud 214 via the internet 234.

In one embodiment, the sensing devices are referred as system acquisition devices and include any device that acquires and publishes data into system session format. Such devices include, but are not limited to, traditional fixed bedside monitors, small form-factor wearable devices, and virtual devices such as digital data recorders and foreign system imports. The flow of information begins with the sensor which provides raw format data to the system acquisition device. A driver application in the acquisition device processes the raw format data into parameter data. The parameter data is then published by the acquisition device into system session format and uploaded to the network. The system session format is a form of parameter data recognized by the cloud which is distributed to display devices.

In one embodiment, a single system acquisition device is assigned to a single patient and there is no sharing of acquisition devices by patients. Multiple sensors and parameters are grouped by the single acquisition device into a unique session for a single patient. In one embodiment, an acquisition device has a local memory store for at least 5 days of patient data. The data stored locally is an exact replica of the data uploaded to the cloud and is published via a replication model. In one embodiment, the system includes peer-to-peer transitive data replication. A majority of the significant databases within the network are replicated across multiple locations using a peer-to-peer model. The peer-to-peer model automatically handles transitive replication and selective replication based on a cost/benefit heuristic. The local memory provides data history and a back up in the event of failure of the overall system.

In one embodiment, display devices are referred to as system presentation devices and include any devices that display data and optionally include alarms. Such devices include, but are not limited to, traditional PCs, tablets, smartphones, and wall monitors. The presentation devices are browser-based, supporting a work anywhere environment. In one embodiment, the system presentation devices include a GUI and provide caregiver workstation functionality. For example, in various embodiments, the GUI of the presentation devices provides for alarm management and quench, patient management (admit/discharge), patient/session association, and retrospective data analysis functionality. In one embodiment, all presentation devices include a common user interface with hyper text markup language 5 (HTML5) as the interface foundation.

Referring again to FIG. 2, the system cloud 214 includes both co-located global health connectors (GHCs) 215 and cloud GHCs 213, all connected to form the system cloud backbone. Each co-located GHC 215 is a small network appliance that is plugged in, switched on, and used in the caregiver setting. In one embodiment, approximately 200-500 beds are allocated to each co-located GHC. The cloud GHCs 213 ensure global reach of the backbone and, in one embodiment, approximately 500,000 beds are allocated to each cloud GHC cluster (8 cloud GHCs). The system cloud 214 hosts the message exchange directory. In one embodiment, all GHCs 213, 215 are peers and all acquisition devices 212 and presentation devices 216 can connect to any GHC 213, 215. Each GHC 213, 215 consolidates session data from the acquisition devices 212 and distributes the data to the presentation devices 216. The system cloud includes domain catalogs organized by accounts, patients, and assets. In addition, in one embodiment, the GHCs are fully replicated for true fail-over redundancy.

In one embodiment, the system cloud includes at least one system cloud domain and a plurality of system cloud departments. A domain is the logically isolated top tier of the system cloud and provides no inter-domain access. The domain typically corresponds to a hospital and is scalable from 10 beds to over 1,000 beds with costs corresponding to the number of beds. All day-to-day functions of the information system occur in the domain. Each user's perspective of the domain is of the entire ‘world’ of the system. In other words, each user is unique and isolated and, if given appropriate access, can see all other users within the same domain. All GHCs, acquisition devices, and presentation devices belong to a domain. In one embodiment, an external device can be used in a domain but it must first be authorized to work in that domain. The system cloud domain contains all hospital data, including, but not limited to, accounts for all caregivers, patient protected health information (PHI), patient session data, asset records, system cloud department information, and presets defining hospital required parameter settings.

Each system cloud department represents a division within a domain and functions to assist in workflows. Each department typically corresponds to a hospital unit and is considered a ‘soft’ division, with almost no restrictions on cross-department access. Caregivers, patients, and devices all have a ‘home’ department so that caregivers can quickly focus on the patients in their department. Most departments are not restrictive and there is no enforcement in the system so caregivers can switch departments as desired. All devices inherit a department at power-on which is determined by the department of the caregiver who logs on. In one embodiment, certain departments are restricted and require prior authorization before being accessed by a caregiver for the first time. For example, caregivers would not be able to access a psychiatric care department without first obtaining authorization. Each department additionally tracks billing events for budgeting.

In one embodiment, the system cloud further includes a system cloud organization which is used for consolidated billing for multiple domains.

### System Security

Each domain of the medical data information system of the present specification is designed as a ‘walled garden’. Each domain will include tightly restricted access, but once inside, a user will be able to move about freely. The security of the system is built as a permissive model with pervasive auditing and logging of all activity. Unusual requests in the system will be handled in a ‘break the glass’ scenario. For example, in one embodiment, users requesting unusual access will be presented with an ‘are you sure?’ type question followed by an audit warning before proceeding. Though the system provides wide access to users, some restrictions are still in place where necessary. For example, a nurse would be unable to delete all accounts. The security of the medical data information system of the present specification is designed such that it can never impede a caregiver from providing patient care. As such, the system will not rely on IT security, encryption, virtual private networks (VPN), or operating system (OS) platform.

Caregivers and administrators will be required to have accounts with user name and password credentials to access the system via acquisition devices, presentation devices, and the internet. In one embodiment, patients and relatives will have special, limited access via the internet and will not require accounts. In one embodiment, users with accounts are also provided with a PIN as short-form credentials. The PIN is intended for use where it will be awkward to enter full credentials, such as, on a numeric keypad. The PIN is hard-wired to an assigned role and is used to switch accounts when multiple users have logged onto an acquisition or presentation device. In addition, PINs are cached on all devices for emergency access when the network is down.

Each account is assigned a set of allowed roles. Each role defines a named set of permissions set up by administration. A user chooses a role, and hence, permissions, during logon. In one embodiment, the roles also specify the list of allowed applications. Roles can only be changed by logging off and then logging back on. Multiple logons to a single system device must all share the same role. Permissions assigned to each role include, but are not limited to, accessing PHI, admit patient, and view data. Each account receives permission only by being assigned a role. In other words, there are no account level rights. An active directory federation maps directory groups to roles, allowing for a majority of account management to be performed in the active directory.

All data, including messages and network traffic, is encrypted using advanced encryption standard 256 (AES-256). In addition, all system devices are validated before being connected to the system cloud. In one embodiment, the decrypt point is at the device message exchange connect point, as the device OS is not considered trusted by the system. To prevent undesired access of sensitive information, PHI data is segregated from clinical data or sessions in separate encrypted databases. Unauthorized access to a single database will not compromise PHI protected by HIPAA. The system includes robust key management and key escrow wherein primary keys are locked in vaults that are keyed to credentials. Cached vaults permit logon even when the network is down. The cloud and local networks utilize the same encryption and the cloud backups are also encrypted.

In an emergency due to network failures, attack by a software virus, or other sources, the system can shut down the connection to the GHC and operate as a stand alone device to acquire and present the physiological data with local alarm messaging.

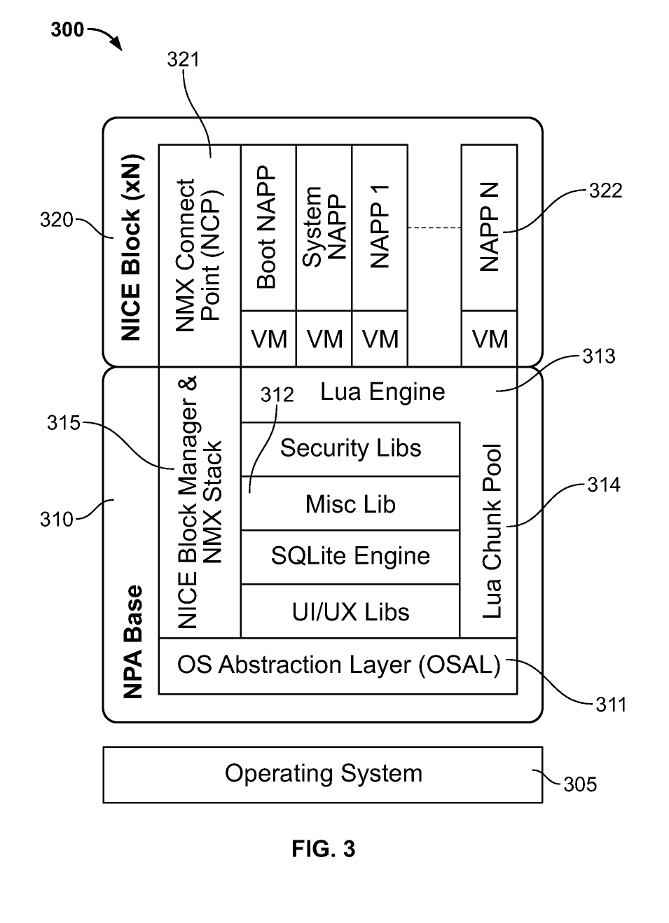

The system utilizes Lua coding and virtual machines (VM) as shown in FIG. 3 to achieve a closed system for reliable security and a portable system extensible by third parties. The VM creates an isolated application where, if malignant input software is connected to the system through the acquisition device, the software is contained to the virtual machine isolated from the system hardware and software. In the case of an attack, the system shuts down the VM while the system can continue to operate for the other patient monitoring applications.

### System Applications

All devices of the medical data information system of the present specification run a system portal application that is the base software stack of the system. Each OS platform (PC, Mac, iOS, Android) has a specific portal application built for that OS that is delivered to the device by OS-specific means (for example, iTunes). The system portal application is packaged as a monolithic binary for each target OS platform. Simply running the system portal application makes the device a system acquisition device, system presentation device, or both. The system portal application is also used in the GHCs and web servers.

Device registration is required before the system portal application may be used. Registration creates an asset record in the system domain for a combination of the device and the system portal application. Registration also assigns a domain message exchange connect ID for message addressing and assigns keys and escrow vaults for encrypted local storage. Registration can be performed offline or directly on the device if permitted. External devices are allowed but require registration to ensure that the device is not polluted.

FIG. 3 is a block diagram illustrating the software architecture 300 of one embodiment of the system portal application. The portal application is a monolithic application loaded as an OS process. The portal application includes a portal application base 310 that instantiates multiple integrated clinical engine blocks 320 to host system applications as needed.

The base 310 contains an OS abstraction layer (OSAL) 311 that isolates the portal application from operating system 305 idiosyncrasies and handles startup, storage, and other OS interfaces. The OSAL 311 is the only part of the portal application that is OS specific, maximizing code reuse. The base 310 also includes a plurality of libraries 312 that provide functional support for executable applications written, in one embodiment, in the Lua programming language. The libraries 312 include security/encryption, standard query language lite (SQLite), zlib, user interface/user experience (UI/UX), and other miscellaneous libraries. One of ordinary skill in the art will recognize that Lua is a light-weight cross-platform programming language designed as a relatively simple scripting language with extensible semantics. Also included in the base 310 is a Lua engine 313 for executing Lua application code in the integrated clinical engine blocks 320. The Lua engine 313 also manages a Lua chunk pool 314 for shared code blocks. The base 310 also contains an integrated clinical engine block manager and complete message exchange protocol stack 315. The portal application base 310 functions essentially as a sophisticated Lua host and contains no active code.

Each integrated clinical engine block 320 functions as a site used to execute system applications. System acquisition devices and system presentation devices each instantiate a single integrated clinical engine block 320. Web servers instantiate one block per active web connection with special handling of connect point IDs via a pool of IDs per server. Each block 320 contains its own message exchange connect point 321 such that each block is ‘seen’ by the cloud as a system device. In addition, each block has its own TCP/IP connection, logon, and permissions. Each block 320 further contains a plurality of individual Lua applications 322, including boot and system applications, which are executed by the Lua engine 313 of the portal application base 310. The base 310 maintains a thread pool to execute Lua applications 322 in the blocks 320. The threads are dispatched to Lua instances as necessary. The Lua applications 322 are event driven. All non-Lua code is identical across all system portal applications.

The Lua boot application is bound to the system portal application and defines the type of device (acquisition or presentation). The boot application is the only application shipped inside the portal application binary and its only function is to logon to the cloud and load the system application. The system application contains the actual functionality of the portal application and serves to load Lua applications as desired.

Lua applications are sold on an online marketplace and are stored as assets. All of the applications are delivered to the portal application on the device, loaded just-in-time (JIT), and executed via the message exchange. Lua application upgrades are placed in the asset catalog and decoupled from more cumbersome portal application upgrades.

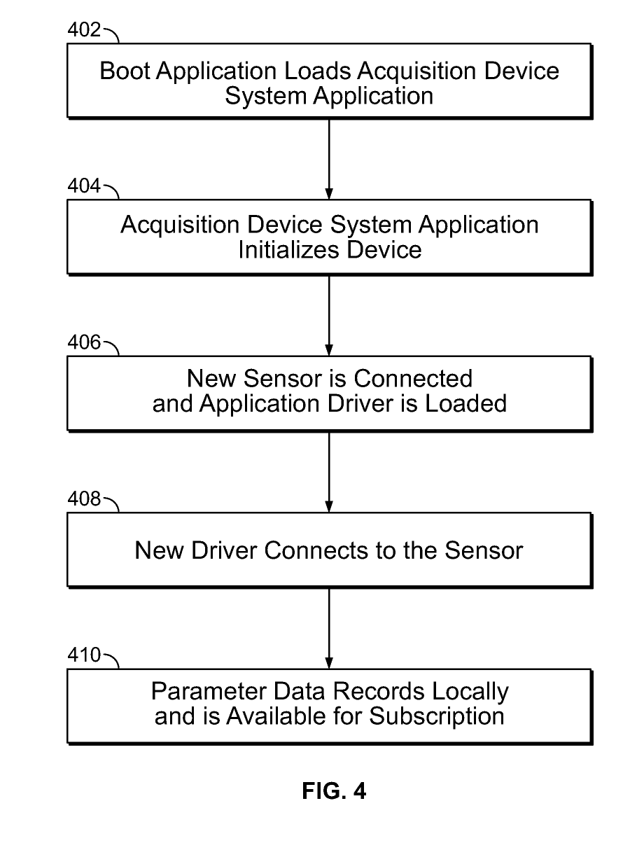

FIG. 4 is a flow chart illustrating the steps involved in initializing an acquisition device in the medical data information system of the present specification. At step 402, a preloaded boot application loads the appropriate acquisition device system application. Then, at step 404, the acquisition device system application initializes the device by registering for sensor detection events and loading appropriate presets. A new sensor is connected at step 406 and the system application receives a sensor connected event, causing the system application to query the sensor for identification to determine the sensor class and type. The system application also queries the asset catalog in the domain for the matching application driver and then loads the driver from the catalog or uses a cached copy. The new driver connects to the sensor at step 408, initializing settings from presets and registering the parameter in the directory. At step 410, parameter data is recorded locally and available for subscription. This comprises the plug and play capability where the system automatically detects the type of sensor device and configures that device to interface with the acquisition device, system alarms and physiological data presentation.

### Message Exchange Protocol

The system for providing patient care of the present specification uses a unique protocol for encoding information to be transmitted across the network. When messages are sent via the system message exchange protocol, a transmitter sends the message with a small computer program using an industry standard scripting language. In one embodiment, the scripting language is Lua. When the receiver receives the message, it executes the contained program and as a result of the execution, receives the desired data. The execution of the message naturally yields data that has already been fully decoded and is ready to be consumed by the receiver with no further processing necessary. The message exchange protocol standardizes the execution of the message on the receiver rather than standardizing the actual content of the message. By operating in such a way, the message exchange protocol changes the contract between the transmitter and receiver from defining the content of a message to defining the result of executing a message.

The message exchange protocol provides greater flexibility in message encoding by allowing the transmitter to create whatever program it wishes when sending a message, as long as the final execution of the program yields the expected data. In addition, new message encapsulations can be developed without the receiver needing to be aware of them, thereby avoiding the problem of the transmitter and receiver having to be updated simultaneously. The message exchange also eliminates decoding overhead by providing final data in a usable form once the contained program has been executed.

In one embodiment, the message exchange is a central, trusted exchange that establishes an encrypted link between itself and each transmitter and receiver. The link between the message exchange and each individual transmitter and receiver needs to be established only one time per transmitter or receiver. A transmitter locally encrypts a message to send with a one-time key (OTK). The transmitter then sends the encrypted message with the OTK using keys exchanged with the message exchange. Since the message exchange is a trusted exchange, it knows the keys of both parties and will decrypt the OTK and then re-encrypt for the receiver. The message exchange then sends the re-encrypted OTK, along with the message, to the receiver. In one embodiment, the protocol described can be used across multiple exchanges in differing locations. The message exchange only has to decrypt and encrypt the OTK and can pass through the message as is, resulting in lower overhead at the exchange. The exchange is connectionless in that the transmitter and receiver never have to exchange keys between one another. Key exchange is done at and by the trusted message exchange, and only needs to be established once per transmitter or receiver. Message keys are tunneled via the trusted (point-to-point) message exchange fabric, without the need to establish endpoint connections, resulting in more efficient message transfer.

In one embodiment, the transmitter embeds its recipient list in the message header and sends it to the exchange. The message exchange replicates the recipient list and then transfers the message to all intended receivers. The message exchange handles all the message distribution, requiring the transmitter to only send the message once regardless on the number of recipients. This enables the transmitter to reduce power consumption. In addition, since the recipient list is included in the header of every message, router operation is able to remain stateless. Therefore, when a device is roaming and moves to a new GHC, the device simply continues sending data to the new GHC without the need to re-sync. The subscription list is already attached in each message.

Since the code from the transmitter is running in the receiver, it is possible for the contained program to execute any legal action in the receiver's execution space. In one embodiment, generation of a return receipt is accomplished by the transmitter sending an exchange message that includes the formation and generation of a return receipt to the original sender of the data as a part of the code contained in the message. When the receiver executes the script, another exchange message is formed by the receiver and sent to the original data sender. In another embodiment, a collection of return receipts are also sent to a data collection server. In this embodiment, the script program sent by the transmitter includes a return receipt generation program directed toward the transmitter and another return receipt generation program directed toward the data collection server.

Therefore, by using a scripting language such as Lua, any message in the message exchange system is capable of generating its own delivery receipt. This allows higher level protocols to describe their own delivery validation semantics without needing additional support from the message exchange fabric. A return receipt is only one example of how exchange messages can be used to encode complex behavior in the receiver that does not require a rigidly maintained protocol between the transmitter and the receiver.

The system message exchange protocol handles all communications between individual devices and between devices and GHCs in the system. The exchange uses TCP/IPv4 or TCP/IPv6 and DHCP with no other network provisioning needed. The message exchange monitors at all times and comprises a simple single connection topology. Each device maintains a single TCP/IP connection to a GHC. The GHCs interconnect to each other to form a switching fabric such that device to device messaging is connectionless and stateless. All firewall connections are outbound with no open ports needed. The simple topology results in a high performance system with low latency and instantaneous switching.

Each integrated clinical engine block of each system portal application functions as a connect point which hosts the actual TCP/IP connection to a GHC. Disconnect/reconnect and subnet migration are transparent to the other applications. The connect point identification is established when the device and portal application are registered with the system. Typically, a single device includes one portal application with one integrated clinical engine block so that there is a single connection to the system. The connect point handles all messages for all applications in each integrated clinical engine block.

The message endpoints are always applications. A unique endpoint includes the domain ID, connect point ID, and application ID. Therefore, each integrated clinical engine block can only have one instance of an application running. In one embodiment, a special case exists for domain catalogs that are always on a local GHC. Well-known services are mapped to reserved polymorphic connect point IDs. In one embodiment, applications can register services with the GHC wherein the service is a global ID that implies message content and sequence.

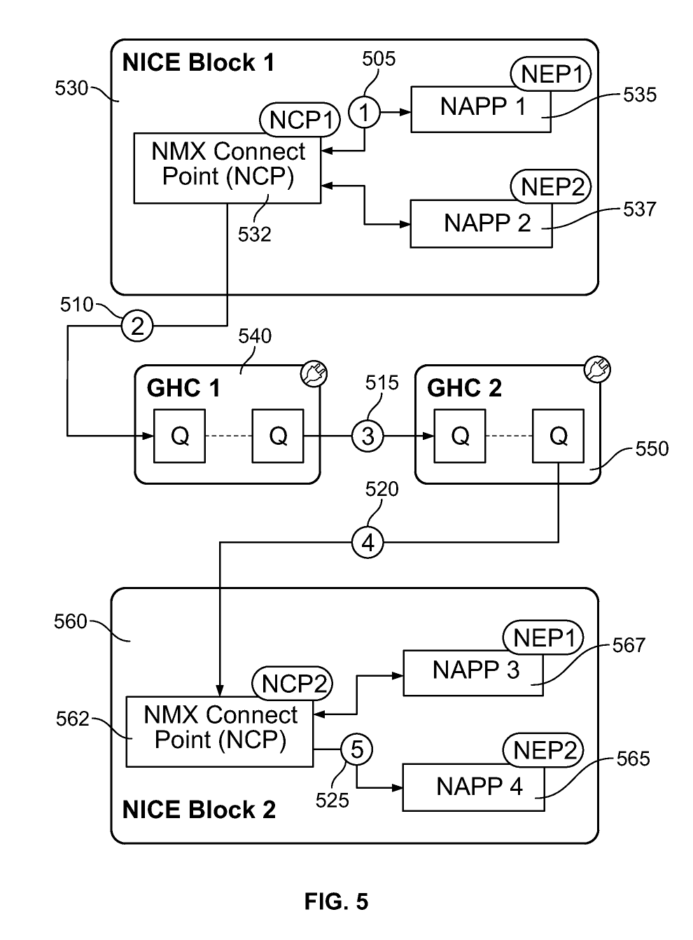

FIG. 5 is a flow diagram illustrating one embodiment of the steps involved in an exemplary message exchange between two applications. Within integrated clinical engine block 1 530, application APP1 535 creates a message for application APP4 565 and sends the message to its message exchange connect point CP1 532 at step 505. Application APP1 535 is the first endpoint EP1 and application APP4 565 is the second endpoint EP2 of the message exchange.

The target application APP4 565 is addressed at the second endpoint EP2 of the message exchange connect point CP2 562 within integrated clinical engine block 2 560. The message exchange stack at CP1 532 segments the message and, at step 510, sends the message segments to GHC1 540. GHC1 540 checks the directory and locates CP2 562 on GHC2 550. At step 515, GHC1 540 sends the message segments to GHC2 550. GHC2 550 receives the message segments and sends them directly to CP2 562 at step 520. The message exchange stack at CP2 562 receives the segments and reassembles the message. At step 525, CP2 562 sends the message to the target application APP4 565. Also illustrated in FIG. 5 are application APP2 537 in integrated circuit engine block 1 530 and application APP3 567 in integrated circuit block 2 560 which represent additional message exchange endpoints connected via CP1 532 and CP2 562.

All messages are segmented, compressed, and encrypted for transmission. Handling of all messages is performed at each end by the connect points. The GHCs simply switch opaque data. Sending smaller message segments allows for more efficient switching in the GHCs and prevents large, low priority messages from blocking higher priority messages. The segments are sent from a first endpoint, through at least one GHC, and then to a second endpoint. Only the segment headers are encrypted and decrypted as the segments hop from one GHC to another. Segments are blocked together for optimal network framing and are marked with a target GHC to make hop routing faster.

In one embodiment, the GHCs that route the exchange message segments use a cost-based routing algorithm that calculates and chooses the best or fastest route using weighted metrics. The metrics are automatically calculated by direct measurement of link performance during actual usage. No initial setup or tuning is necessary. The routing protocol reacts dynamically to underlying network congestion, outages, and changes to avoid unnecessary cloud costs while also preserving a full cloud fallback in the event of network failure. During operation, the GHCs exchange routing cost metrics to automate traffic balance. By reacting to direct measurements of actual link performance, the system routes segments efficiently while minimizing bandwidth usage.

In one embodiment, the system for providing patient care of the present specification ‘bundles’ data into messages of reasonable size to minimize the power used to transmit a given volume of data. ‘Bundling’ data together into larger messages results in an increase in the delay between when a message is created and when it is sent to the receiver but requires less power from the transmitter. Since many transmitters in a hospital setting can be mobile devices, ‘bundling’ messages serves to prolong battery life. Examples of data continually acquired by transmitting devices include ECG, blood pressure, and pulse oximetry waveforms. In a non-emergency situation, this data can be ‘bundled’ and sent together to preserve power. Urgent messages, such as life-threatening clinical alarms or critical system messages, will be sent individually and immediately.

As messages are generated by the system applications, they are queued at the control point (NCP). Part of the queuing process includes determining message priority. For example, in one embodiment, messages are labeled as system, urgent, high, medium, and low priority with the highest priority messages sent first. Bandwidth reservation avoids low priority message starvation. Non-urgent messages from a specific application are always sent in-order with urgent and high priority messages causing early IP buffer flushing. In one embodiment, a ‘background option’ defers lower priority messages until the system sends the next group of ‘bundled’ messages. Each instance in which the system sends a group of ‘bundled messages’ is termed a system ‘heartbeat’. In one embodiment, the ‘heartbeat’ occurs at a low frequency (0.5 to 10 Hz).

In one embodiment, the system implements a publication and subscription (Pub/Sub) mechanism that guarantees data intended for use by multiple subscribers or receivers will be produced by the source device or transmitter only once. For example, it is not uncommon for a mobile monitoring device used in the system to have multiple consumers of the device's acquired data. A typical mobile monitor may be generating alarms and vitals that are used by multiple caregivers (nurse, supervising nurse, physician), all of whom may be monitoring the same patient on different devices (some of which may be mobile themselves). In addition, the vitals and real-time waveforms and trends may be continuously displayed on bedside and central monitors that are hard-wired to the network.

In this example, each caregiver's device (and the hard-wired units) would have active subscriptions to the data being produced by the mobile monitor. In this case, the mobile monitor transmits the monitoring data one time from the device to the nearest GHC. The message that is transmitted will include the addresses of all recipients of the device's data. The GHC will interpret the list of addresses and ensure that duplicate data is sent to all the recipients.

The CP on the source device will be monitoring all active subscriptions to the data and ensuring that the routing information for each subscriber is included in the single message packet that is sent to the GHC. When the data is received by the GHC, it will create new messages that are bound for each of the subscribing devices. Note that the duplication of the data at this point is no longer “expensive” because the GHC is a hard-wired, wall-powered device with a fast network connection.

The message exchange protocol is optimized for low power devices. In one embodiment, the output flow control is optional as it is not necessary on devices that are not power constrained. The background option lessens traffic and optimizes WiFi radio use by sending messages in bursts. In addition, publish/subscribe (Pub/Sub) data is only sent once from a device. Reducing the total WiFi traffic improves device battery life and reduces the load on the network. The ‘heartbeat’ handles alerts when a connection is down and also sends status, metrics, stall list, and location/presence updates.

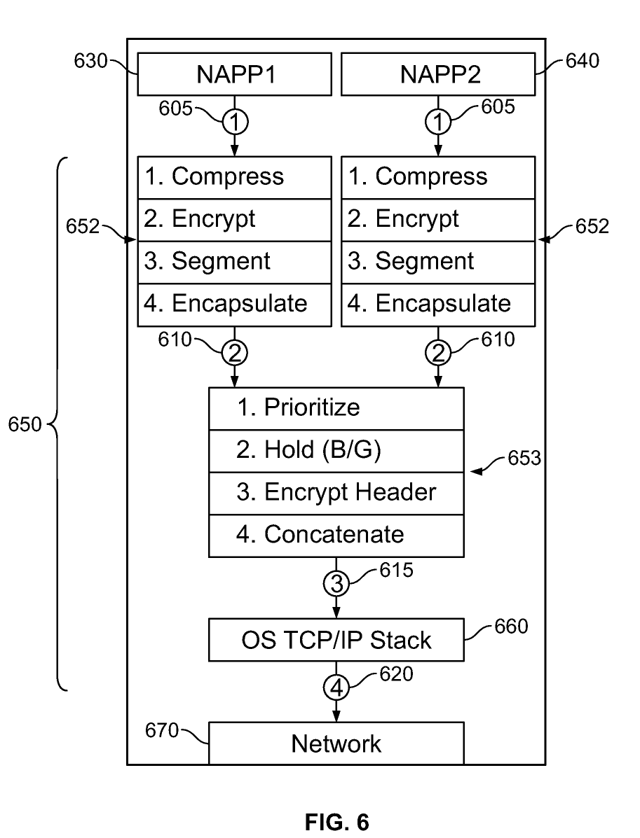

FIG. 6 is a flow diagram illustrating one embodiment of the flow of messages from a pair of applications in the medical data information system of the present specification. At step 605, application APP1 630 and application APP2 640 each send a message to the message exchange stack/connect point 650 for delivery to another application (not shown). The message exchange 652 compresses and encrypts each message individually using a derived key. The message exchange 652 then segments each message and encapsulates the segments. At step 610, the message exchange 652 sends the encapsulated segments to the connect point queue 653. The message segments are then prioritized and background messages are held until the next ‘heartbeat’. The segment headers are encrypted and the segments are concatenated together. At step 615, the concatenated segments are sent to the OS TCP/IP stack 660. From there, the segments are sent to the network 670 at step 620 and to the connected GHC for routing.

Publish/subscribe (Pub/Sub) is a service contract handled at the connect point in the integrated clinical engine block and is therefore shared by all applications. The connect point handles tracking subscriber lists and expands publish message with a list of subscriber endpoints. The connect point sends message segments only once to a GHC with the subscriber list. The GHC then forks segments as necessary to reach all subscribers. This routing of message segments minimizes network traffic and battery drain on the publisher. When necessary, the subscriber must re-establish subscriptions as the publisher does not persist subscriptions. The subscriber should re-subscribe if the publisher goes dark to avoid orphaned subscriptions.

The directory of the message exchange is an in-memory database maintained by each GHC and is backed by SQLite to scale to millions of entries. In one embodiment, the directory replicates across all GHCs in a domain within 2-5 seconds. The replication trigger (dirty flag) piggybacks onto a ‘heartbeat’. In one embodiment, the directory includes a registry of all devices, endpoints, and services and also maintains device locations. Determining a device location can assist a caregiver in finding a patient. In one embodiment, the last known location is also persisted to the asset catalog when a device is flushed. The directory is also extensible for 3^{rd} party device discovery.

In one embodiment, the majority of messages sent via the exchange are sent as Lua source code. The use of Lua is secure as control is maintained over the network and the portal application. Lua source coding provides simple message decoding. For example, in one embodiment, a user can call “loadstring( )” on the message content to obtain values. In addition, Lua source coding provides for a faster system, as the Lua parser is optimized for datasets (>300/sec on a tablet). Use of Lua source code changes the paradigm of message service contracts by eliminating rigid fixed-format messages and by basing the contract on the effect of the message upon receipt and execution. Return receipts for messages are generated by adding code in the message.

### Patient Sessions and Clinical Data

In the medical data information system of the present specification, a patient session is a container for all clinical data gathered from the patient. Each session is created by the system acquisition device when collecting patient data. In addition, each session is identified per device by a globally unique identifier (GUID). Sessions are cumulatively immutable as they can only ever be appended. In one embodiment, each session is divided into one hour ‘strips’ to avoid dangling sessions. The sessions themselves are anonymous, containing no protected health information (PHI). The data in each session is definitive, including all data, and can be replayed much like the content of a digital video recorder. In addition, in one embodiment, each session includes all clinical data and alarms, setting changes, and a record of who made the changes.

In one embodiment, sessions originate in the system acquisition devices and are stored and distributed in the GHCs. The GHCs collect all session strips using a replication protocol.

Lag in replication is typically only a few seconds such that retrospective data is rapidly available for analysis. In one embodiment, cloud GHCs only collect session strips on-demand.

Patient association with a session is decoupled from a session lifetime. A new session can be created for a patient without having to admit and the association can be done at the start of, during, or after the session. ‘Breadcrumbs’, such as voice notes, assist with session association. In one embodiment, annotations against a span of time are kept in the patient record. In one embodiment, the annotations can be manual or synthetic (e.g. created from alarms). In terms of session archiving and storage, in one embodiment, after a basic retention period, a session can be trimmed. In one embodiment, trimming a session involves discarding non-alarmed and non-annotated waveform data. A trimmed session is migrated to the cloud and discarded from the GHCs. By moving trimmed sessions to the cloud, the system provides essentially infinite storage dependent on how long the customer decides to pay for the storage.

### Alarm Routing and Alarm Quenching

In one embodiment, the system for providing patient care of the present specification a method of alarm priority routing based on the location and presence information of both the patient and caregivers. In one embodiment, the method of alarm priority routing is similar to that disclosed in U.S. patent application Ser. No. 13/300,434, entitled “System and Method for Transfer of Primary Alarm Notification on Patient Monitoring Systems”, filed on Nov. 18, 2011 and assigned to the applicant of the present invention, which is hereby incorporated by reference in its entirety.

In one embodiment, the system of the present specification will route primary alarms to the nearest available responder, thus minimizing the time taken between alarm and response from the caregiver. In one exemplary embodiment, a first caregiver is designated as a responsible operator for a patient (is directly responsible for said patient). The first caregiver assigns his or her mobile alarm display device to receive alarms for the patient. A critical alarm for the patient annunciates on the mobile device. The first caregiver looks at the display on the mobile device and determines that the patient is still in bed and that a second caregiver (operator) is already at the patient's bedside. The first caregiver presses the name of the second caregiver on the display of the mobile device and is immediately placed in two-way voice communication with the second caregiver in order to assess the situation.

In another exemplary embodiment, a telemetry patient leaves the unit to go for a walk. When out of the unit, the patient enters cardiac arrest and collapses. A telemetry monitor worn by the patient issues a high priority alarm. The system of the present specification, based on knowledge of the patient's physical location, alerts the patient's responsible operator in the telemetry ward and two additional operators nearer to the patient's current location to assist. The system additionally places all three caregivers in communication via their mobile devices until the situation is resolved.

In another embodiment, the system includes a device alert wherein specific alarms are delivered to handheld devices carried by preselected caregivers. For example, the system can send an alert to a doctor or nurse's PDA in the ICU/CCU. A predetermined set of distributed caregivers will receive the priority alarm. This selective notification means that not everyone on the network gets the alert. For example, if a caregiver is in room 5, then the system can target alarms to that caregiver. Caregiver location notification can also be specified to a particular skill set. In one embodiment, there is a master dispatcher that is notified of all alerts to ensure response. Targeting an alert and assigning it to selected caregivers enhances response efficiency of the system by ensuring that the most appropriate caregiver will receive the alert first.

In one embodiment, the system for providing patient care of the present specification also provides a distributed and caregiver team oriented method for managing alarms. The method provided silences or ‘quenches’ alarms. When an alarm condition is detected by a device connected to a patient, the system will notify the appropriate caregivers for the patient that the alarm condition is occurring. Any of the operators receiving the alarm message with appropriate rights to do so may “quench” the alarm. Quenching alarms by an operator puts all the devices currently displaying the alarm information into a ‘quenched state’ which may either silence the device or have the same behavior as a traditional alarm acknowledge operation. The quench operation indicates to other operators that the alarm condition has been observed and that an authorized operator is taking appropriate action.

In one embodiment, an “alarms quenched” state applies to all acquisition devices associated with a patient and will persist until either a timeout period elapses or a new alarm condition with higher priority than what was quenched is detected. If either of these conditions occurs, then the alarms quenched state is cleared and the alarm display devices all display the full alarm signals as appropriate for the present set of alarm conditions.

In one embodiment, initiating a quench while already in an alarm quenched state will reset the timeout and reset the alarm quenched priority based on the set of currently present alarm conditions. In one embodiment, any operator has the ability to cancel an alarms quenched state and return all alarm display devices to full alarming functionality.

### Optional Features

In various embodiments, the system for providing patient care of the present specification further includes any one or combination of the following optional features.

In one embodiment, display devices of the system are capable of providing logarithmic display of waveforms. By logarithmically compressing the time scale at the far left and right edges of a waveform display, the system cues users that additional data is available. A caregiver can naturally “swipe” in these areas to move the data into focus in the central part of the waveform. A caregiver can also switch to a linear view of the data after locating a section of the waveform the caregiver would like to review in more detail.

In one embodiment, system devices include voice alarms in addition to the traditional “bong” alarm sounds. For example, voice synthesis added into a headset worn by caregivers provides additional alarm details including alarm cause, patient location (for example, room, surgery, etc), and patient name.

In one embodiment, system devices provide outpatient care regimens for patients upon discharge or for outpatient care. When patients take a monitoring device home for outpatient care, the device is capable of providing additional help for care including readable outpatient instructions that traditionally are given orally at discharge, drug regimens, including built-in calendar reminders, the ability to scan quick response (QR) codes on prescription drugs to verify drug regimens, and other similar tasks.

In one embodiment, QR codes are used to assist in location services. In addition to advanced technologies such as Wi-Fi triangulation and near field communication (NFC), simply printing QR codes and pasting them next to doors provides an inexpensive method of location awareness that is particularly applicable to emerging markets. Cameras in caregiver devices are used to quickly snap the code and provide location awareness.

In one embodiment, the system includes smart on-wall displays for providing both patient information and entertainment for patients and families. Display devices in a patient room act as entertainment hubs when caregivers are not present, but switch automatically to provide patient care information as soon as a caregiver enters the room. In one embodiment, the system provides a dual display configuration as described in U.S. patent application Ser. No. 13/052,883, entitled “Multi-Display Bedside Monitoring System”, filed on Mar. 21, 2011 and assigned to the applicant of the present invention, which is hereby incorporated by reference in its entirety.

The system provides a dual display monitor which can be set up at a patient bedside to provide aggregated medical information related to the patient along with the patient's real time vital statistics. One of the two displays continuously shows the real time patient monitoring information whereas the other is used to display information such as when medicines were delivered, show lab results in reference to vital signs, and provide access to other remote hospital applications, typically only accessible via separate data terminals. The dual display monitor is connected to the hospital information system and has the capability of displaying local software applications and remote software applications via remote display software, such as, software made available by Citrix™. In addition, the dual display monitor can be connected to a central monitor configuration that can include up to four additional displays. These additional displays can be used to monitor more patients, display additional data, and/or host other applications.

Additionally, in further embodiments, the local and remote software applications accessed on the dual display monitor also comprise applications other than those just related to providing patient monitoring functionality. For example, such software could be an entertainment application; internet or other network connectivity application; or a patient education application or an email or video conferencing application or any other value-added application that would be advantageously evident to those of ordinary skill in the art.

In one embodiment, the dual display monitor can be enabled in either patient mode or caregiver mode. In patient mode, clinical settings cannot be changed but a controlled list of approved software applications, such as entertainment or patient education, can be run. The monitor is in patient mode unless a caregiver is in the room. Thus, for example, when the patient is in the room unattended, the monitor would typically be in patient mode. The mode can be changed remotely by a caregiver. To change into caregiver mode, the monitor is enabled to take a credential, password or RFID badge. In one embodiment, context sensitive disabling or minimization of patient mode is enabled. Thus, in the event of a change in clinical state [for example a certain alarm class (high priority)] the patient's application is disabled or minimized until cleared by a caregiver. Ideally this would be configurable by the caregiver by alarm type or alarm class.

In one embodiment, the system provides a plug and use algorithm cascade that enhances and streamlines data gathering among devices. When a sensor is connected to a device, it triggers the loading of the appropriate driver application. This driver, in turn, publishes clinical data from the device. This data is modeled as a virtual sensor that causes another driver application to load that further processes the data, thus causing a “cascade” of driver loads as necessary. This allows smart alarm drivers to load and gather data from multiple devices.

In one embodiment, the system provides for self-assembling cascading medical data flow by describing a medical data algorithm as a functional block with defined inputs and outputs. When a particular output is desired, the set of blocks can self-assemble by using the metadata to connect inputs and outputs in a reverse (consumer provided) cascade. This is applicable both to real-time data and retrospective analysis. In addition, the set of available outputs is easily computed from the available raw inputs and algorithmic permutations.

In one embodiment, a system device can self-test to determine if it is capable of acting as an alarm display device. In various embodiments, not all system devices will be capable of acting as an alarm display device. Limitations may be in the devices ability to generate loud enough audible tones or to visually display large enough messages to meet usability requirements. A self-test is performed by an application installed on the device and the results are used by the system to determine if the device is capable of acting as an alarm display device.

In one embodiment, the system provides a means for aggregating and storing a patient's data in a single file so that it can be accessed by any caregiver at any time during the patient's stay in the hospital. In one embodiment, the means includes a single PC based device capable of displaying data for up to 64 patients in a real-time remote view. The device can also be coupled to four additional displays to improve viewing.

The device includes a robust user interface for presenting patient data on a retrospective basis. The device functions as a centralized remote station for viewing all of a patient's data as if the data were embedded into the device. Caregivers are able to view the clinical data from any location and at any time.

In addition, in one embodiment, the device provides for patient association and identification in the form of a patient record manager and session tracker. With conventional patient monitoring systems, data storage is device-centric, rather than being patient-centric. As such, patient data might still reside in the device in the room, even after the patient has been discharged. In addition, with conventional systems, medical record numbers (MRN) and identification numbers can be confused. By incorporating a patient record manager and session tracker, a new session is started to go through re-association whenever data flow stops. Each patient is associated with an electronic serial number. Therefore, when a patient is disconnected from one monitoring device and re-connected to another monitoring device, the patient is re-associated to the new device. In one embodiment, sessions can be merged so that all patient data from the various devices can be viewed in total.

Patients can be associated to different monitoring devices via a number of association methods. In various embodiments, these include automatic retinal scanning, biometric patient identification, and sensor based identification. For example, association can be accomplished by collecting and analyzing a DNA sample, analyzing a fingerprint, or by some other non-invasive procedure. Each association method identifies the patient and coordinates the device and the data record from the device with that patient. Once established, the association between a specific device and a single patient is always present and there is never any problem of establishing a duplicate association. This also avoids the problem of losing a device-patient association that occurs when an RFID bracelet is broken.

In another embodiment, each patient is associated with a device by a tag or lanyard that is passed between caregivers and would need to be notified at any given time during the care of the patient.

In one embodiment, the system also provides for association between a caregiver device and patient data. Each caregiver can customize display on the handheld device based on what that person wants. The above examples are merely illustrative of the many applications of the system of the present invention. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

We claim:

1. A system for providing patient care comprising:
a. a first computing device having a first volatile or non-volatile computer readable medium, not including transmission media for transmitting waves, wherein said first medium comprises:
i. a first plurality of programmatic instructions, wherein, when executed by said first computing device, said first plurality of programmatic instructions:
1. encrypt, using a standard scripting language, an executable program and attach said encrypted program to the header of a message; and,
2. transmit said message from the first computing device to a second computing device via a wireless connection;
b. a second computing device having a second volatile or non-volatile computer readable medium, not including transmission media for transmitting waves, wherein said second medium comprises:
i. a second plurality of programmatic instructions, wherein, when executed by the second computing device, said second plurality of programmatic instructions:
1. receive said message from said first computing device;
2. determine, from said message, at least one target computing device intended to receive said message; and,
3. transmit said message from said second computing device to said at least one target computing device via a wireless connection; and,
c. at least one target computing device having a third volatile or non-volatile computer readable medium, not including transmission media for transmitting waves, wherein said third medium comprises:
i. a third plurality of programmatic instructions, wherein, when executed by the third computing device, said third plurality of programmatic instructions:
1. receive said message from said second computing device;
2. decrypt said executable program; and,
3. execute said executable program and thereby receive said message;
wherein said second computing device is a cloud based computing device.

2. A system for providing patient care comprising:
a. at least one sensing device configured to detect and report at least one physiological parameter of a patient;
b. at least one acquisition device coupled to said at least one sensing device wherein said acquisition device receives electronic patient data from said at least one sensing device and includes memory capable of storing said patient data;
c. at least one network appliance coupled to said at least one acquisition device wherein said network appliance is configured to receive said patient data from said acquisition device;
d. a network for providing cloud computing wherein said at least one network appliance is coupled to said network and wherein said network includes a database for storing said patient data such that said patient data is accessible across all network devices; and,
e. at least one presentation device coupled to said network wherein said presentation device is configured to access said patient data and display said patient data on a graphical user interface,
wherein transmission of said electronic patient data across said network includes encrypting said patient data by encoding an executable program using a standard scripting language and attaching said program to a message that includes said patient data.

3. The system for providing patient care of claim 2, wherein said network appliance is located in proximity to the patient.

4. The system for providing patient care of claim 2, wherein said network appliance is located remotely from the patient.

5. The system for providing patient care of claim 2, wherein said at least one sensing device is coupled to said at least one acquisition device via a wired connection.

6. The system for providing patient care of claim 2, wherein said at least one sensing device is coupled to said at least one acquisition device via a wireless connection.

7. The system for providing patient care of claim 2, wherein said at least one sensing device and said at least one acquisition device can connect to the network via a 3G/4G connection.

8. The system for providing patient care of claim 2, wherein said standard scripting language is Lua.

9. The system for providing patient care of claim 2, wherein said presentation device comprises any one of a traditional PC, tablet, smartphone, or wall-mounted display.

10. The system for providing patient care of claim 2, wherein said acquisition device also functions as a presentation device.

11. The system for providing patient care of claim 2, wherein said acquisition device duplicates and stores all clinical data for said patient on said memory and functions as a standalone monitor in the event of system failure.

12. The system for providing patient care of claim 2, wherein said acquisition device is a fixed device at a caregiver facility.

13. The system for providing patient care of claim 2, wherein said acquisition device is a mobile device that remains with said patient upon discharge and for outpatient care.

14. The system for providing patient care of claim 2, further including a cost-based routing algorithm that calculates the most efficient message route by directly measuring current network performance during actual usage.

15. The system for providing patient care of claim 2, further including an alarm routing protocol that routes alarm priority based on the location and presence information of both said patient and a caregiver.

16. The system for providing patient care of claim 2, wherein a caregiver can silence or reduce in volume an audible alarm for all devices assigned to said patient.

17. The system for providing patient care of claim 2, further including a central trusted message exchange that establishes a once-per-device encrypted link between the exchange and each message transmitter and receiver.

18. The system for providing patient care of claim 17, wherein said central message exchange clusters non-urgent messages to be sent periodically.

19. The system for providing patient care of claim 17, wherein said message transmitter is configured to send each message only once and said central message exchange is configured to duplicate and send each message to multiple recipients based on a subscription list included in a header of said message.

20. A method for providing patient care comprising the following steps:
a. providing a patient care system that comprises:
i. at least one sensing device configured to detect and report at least one physiological parameter of a patient;
ii. at least one acquisition device coupled to said at least one sensing device wherein said acquisition device receives electronic patient data from said at least one sensing device and includes memory capable of storing said patient data;
iii. at least one network appliance coupled to said at least one acquisition device wherein said network appliance is configured to receive said patient data from said acquisition device;
iv. a network for providing cloud computing wherein said at least one network appliance is coupled to said network and wherein said network includes a database for storing said patient data such that said patient data is accessible across all network devices; and,
v. at least one presentation device coupled to said network wherein said presentation device is configured to access said patient data and display said patient data on a graphical user interface,
b. detecting and reporting said at least one patient physiological parameter using said at least one sensing device;
c. transmitting electronic data representative of said at least one physiological parameter to said acquisition device;
d. encrypting said patient data by encoding an executable program using a standard scripting language and attaching said program to a message that includes said patient data;
e. transmitting said encrypted data to said network appliance;
f. storing said data on said network using cloud computing;
g. accessing, decrypting, and displaying said data using said presentation device.
